(19) United States
(12) Patent Application Publication
(10) Pub. No.: US 2008/0097724 A1
(43) Pub. Date: Apr. 24, 2008

(54) Programmable data acquisition device

(76) Inventors: Quintin Morris, Brooklyn, NY (US); Curt Croley, Stony Brook, NY (US); Alistair Hamilton, Stony Brook, NY (US); JaeHo Choi, Whitestone, NY (US)

Correspondence Address: FAY KAPLUN & MARCIN, LLP, 15O BROADWAY, SUITE 702, NEW YORK, NY, 10038, US

(21) Appl. No.: 11/585,637

(22) Filed: Oct. 24, 2006

(51) Int. Cl. G06F 19/00; G06F 17/40

(52) U.S. Cl. 702/187; 702/1; 702/127; 702/189

(57) ABSTRACT

Described is a wearable data acquisition device which includes (i) a data acquisition arrangement to collect data and (ii) a trigger arrangement activating one or more functions. The functions may include an activation of the data acquisition arrangement and/or a data operation function. An operation of the trigger arrangement corresponds to each of the functions is programmable.

### FIELD OF THE INVENTION

The present invention generally relates to wearable data acquisition devices.

### BACKGROUND INFORMATION

A scanning procedure associated with a conventional wearable data acquisition device, such as a ring scanner, often involves multiple user actions to complete the scanning. For example, the conventional data acquisition device may have a trigger button for initiating the scan. However, completion of the scan may require the user to accept the scan by, for example, interacting with a processing unit (e.g., a computer) coupled to the data acquisition device. Additional user actions are therefore time-consuming. In addition, if an item being scanned occupies the user's attention, the user may be required to direct attention away from the item (e.g., releasing the item from a hold) in order to perform the addition actions.

### SUMMARY OF THE INVENTION

The present invention relates to a wearable data acquisition device which includes (i) a data acquisition arrangement to collect data and (ii) a trigger arrangement activating a plurality of functions. The functions include one of activating the data acquisition arrangement and a data operation function. An operation of the trigger arrangement corresponds to each of the functions is programmable.

### BRIEF DESCRIPTION OF THE DRAWINGS

FIG. 1 is an exemplary embodiment of a first data acquisition device according to the present invention;

FIG. 2 is an exemplary embodiment of a second data acquisition unit according to the present invention

FIG. 3 is an exemplary embodiment of a first function table according to the present invention;

FIG. 4 is an exemplary embodiment of a second function table according to the present invention; and

FIG. 5 is an exemplary embodiment of a third data acquisition unit according to the present invention.

### DETAILED DESCRIPTION

The present invention may be further understood with reference to the following description and the appended drawings, wherein like elements are provided with the same reference numerals. The present invention relates to wearable data acquisition devices. An exemplary embodiment of the present invention is described with reference to a ring scanner, however those skilled in the art will understand that the present invention may be implemented with any type of wearable data acquisition device, such as a wrist-mounted scanner, a glove scanner, etc. It will also be understood that the present invention is not limited to barcode scanners, but may also include RFID readers, laser-/image-based scanners, card readers and other types of data acquisition devices.

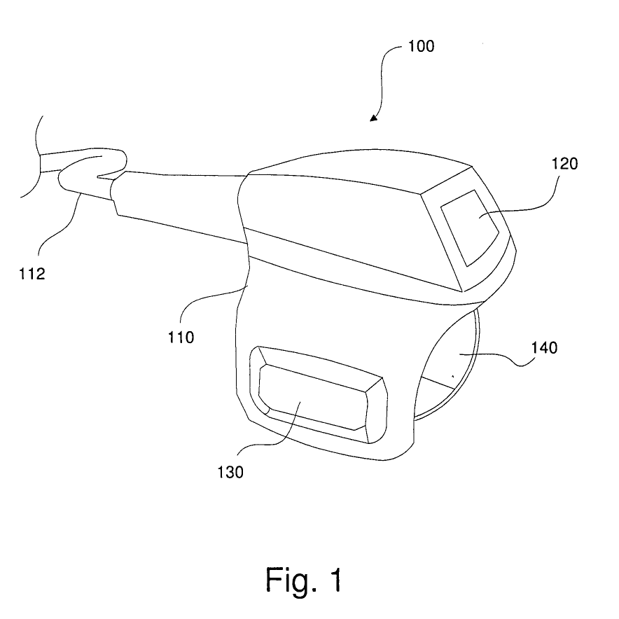

FIG. 1 shows an exemplary embodiment of a data acquisition device (e.g., a ring scanner) 100 according to the present invention. The scanner 100 includes a housing portion 110, which comprises a scanning arrangement (e.g., a barcode scanner) 120 and a trigger 130. The housing 110 may be coupled to a communication arrangement, such as data cable 112, which transfers data to and/or from the scanner 100. For example, the data cable 112 may include a hardware connector (e.g., a parallel port connector, a serial port connector, a USB connector, etc.) that couples the scanner 100 to a data processing/storage device such as a computer, a PDA, a mobile terminal, etc. Thus, the data cable 112 may allow the scanner 100 to transmit scanned images to the data processing device and receive instructions therefrom.

The trigger 130 may be a pushbutton, a slide switch, a rocker switch, or any other conventional manual switching device. As would be understood by those skilled in the art, the trigger 130 may comprise mechanical and/or electrical components. Although the term “trigger” is used herein to refer to a pushable trigger, the trigger may, in other embodiments, be any input mechanism such as a gun-style trigger, a button, a touch sensitive device, a piezoelectric switch, etc. In an exemplary embodiment, the trigger 130 comprises a substantially convex flexible membrane (e.g., plastic, rubber, etc.) encasing a trigger mechanism. The trigger 130 may be activated by depressing the membrane, thereby engaging the trigger mechanism.

The data acquisition device 100 may also include a strap, a band, or other attachment arrangement 140, whereby the device 100 can be worn by a user. In an exemplary embodiment, the strap 140 is sized to fit around an index finger of the user, such that when the device 100 is worn, the trigger 130 is positioned on a medial side of the finger, facing a thumb of the user. Thus, the trigger 130 may be thumb-activated. Those of skill in the art will understand that scanning of an item (e.g., a bar-coded item) may require the user to pickup the item and move the item in front of the scanning arrangement 120 (e.g., by swiping the item). Thus, both of the user's hands may be occupied by the scanning procedure.

The processing device may be, for example, a dedicated computer running a scanning application, which accesses a database for storing and retrieval of scanned data. The scanning application may include a user interface (e.g., a graphical user interface) for interacting with the user. According to an exemplary embodiment of the present invention, the scanning application enables the user to modify a functionality of the trigger 130. For example, the trigger 130 may initially be configured to initiate a scan when engaged. As will be discussed below, the functionality may be modified by adding, removing, and editing a manner in which the functions are accessed (e.g., triggering patterns). In an exemplary embodiment, the modification may only be performed while in a training mode. However, other embodiments may allow the user to perform the modification at any time. The training mode may be initiated using either the processing device or the device 100.

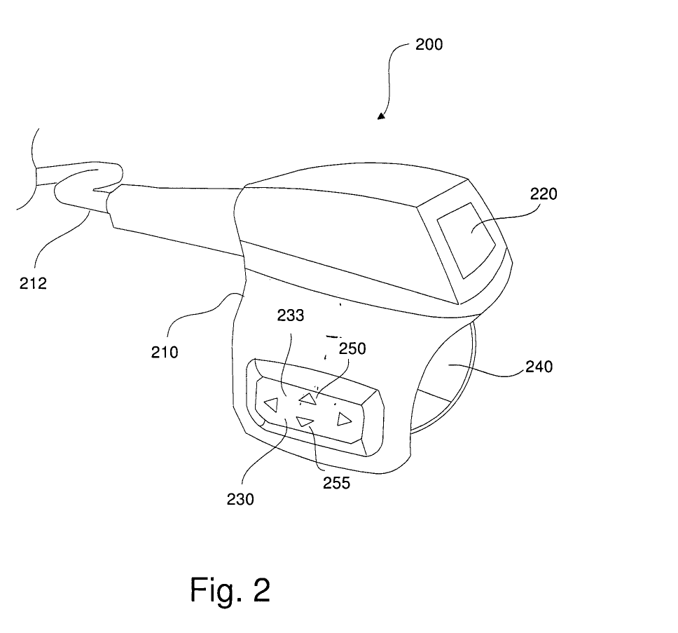

FIG. 2 shows an exemplary embodiment of a data acquisition device 200 according to the present invention. The device 200 utilizes a touch sensitive trigger 230 and may include a housing 210 comprising a scanning arrangement 220. The device 200 may also include a communication arrangement 212 and an attachment arrangement 240. The trigger 200 may be implemented using any touch sensitive technology known in the art, such as a capacitive, inductive or infrared touch screen technology. The trigger 230 may be similar in shape to the trigger 130 and may, for example, feature an overall convex shape with a flat triggering surface 233. The triggering surface 233 may be labeled to indicate functional portions thereof. For example, the triggering surface 233 may be labeled with one or more arrows that indicate the functional portions. For example, an “Up” arrow 250 may correspond to a first function, a “Down” arrow 255 may correspond to a second function, etc.

The functional portions may be activated by a thumb touch. In addition, two or more functional portions can be used in combination to enable additional functions (e.g., closing a scanning application, toggling a scanning application, etc.). For example, if the user touches the Up arrow 250 and moves his thumb to the Down arrow 255 while continuing to engage the triggering surface 233, this may correspond to a scrolling operation. Thus, the trigger 230 may be used to navigate a particular scanning application. Other motions and/or combinations (e.g., clockwise, counterclockwise, a quarter-circle, etc.) may also be possible.

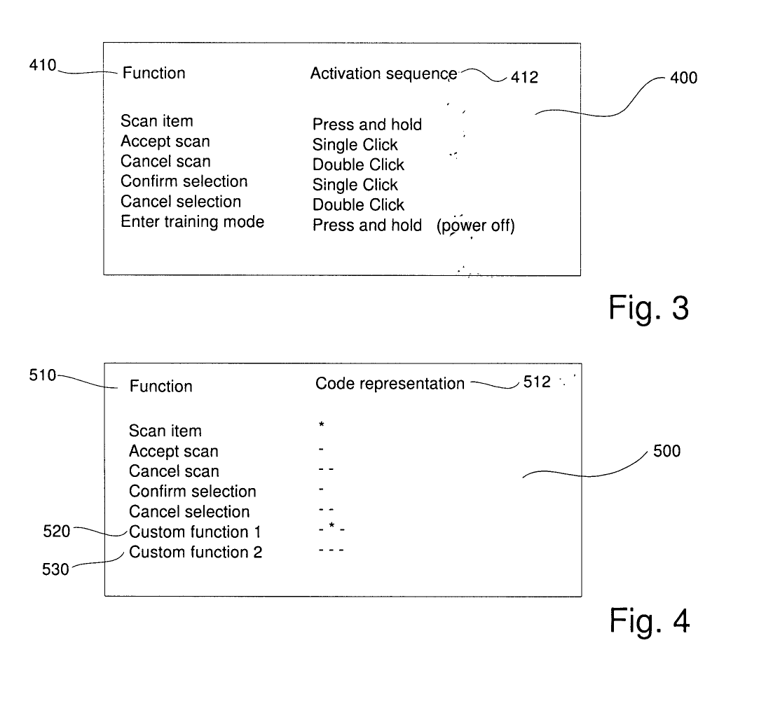

FIG. 3 shows an exemplary embodiment of a function table 400 according to the present invention. The function table 400 may include a function list 410 and a corresponding activation sequence list 412. The function list 410 comprises a first set of functions, which may be accessed by engaging the trigger 130. The activation sequence list 412 comprises a corresponding first set of triggering patterns. For example, the function list 410 may include a “scan item” function that is activated by pressing and holding the trigger 130. Other functions may include accepting a scan, canceling a scan, confirming a selection (e.g., confirming a scan acceptance), canceling a selection, and entering the training mode when the device 100 is powered off.

As would be understood by those skilled in the art, the first set of functions may be predetermined functions. That is, the first function set may include functions that are essential to a basic functionality of the device 100, and are therefore preprogrammed or hard-wired into the processing device and/or the device 100. For example, the scanning application may include a default configuration that includes the “scan item” function and “press and hold” as a corresponding default triggering pattern.

As shown in FIG. 3, an activation sequence may comprise engaging the trigger 130 one or more times. In addition, the trigger 130 may be engaged for varying durations. One type of engaging may be a “hold,” which is defined as a continuous engaging of the trigger 130 for a predetermined duration. For example, a hold may be defined as engaging the trigger 130 for at least two seconds. Another type of engaging may be a single or double “click,” which is defined as a momentary engaging of the trigger 130. The double click includes a pause between clicks in which the trigger 130 is momentarily disengaged. The duration of the pause may be predetermined and stored in a memory (e.g., RAM, a hard disk, a network drive, etc.) of the processing device and/or the device 100. In an exemplary embodiment, the durations of the hold and the pause may be modified from default values corresponding to the default configuration used by the scanning application. If the user has a preference for faster clicking, the hold and/or pause durations may be decreased. Similarly, if the user prefers to engage the trigger 130 slower than the default values allow, the durations may be increased. The sequence of actions that produce the first set of functions could be designed to activate only after a successful decode from the scanner, imager or RFID module (e.g., a double click following a successful decode).

FIG. 4 shows an exemplary embodiment of a function table 500 according to the present invention. The function table 500 includes a function list 510, which may comprise a second set of functions substantially similar to those of the first function set. For example, the second function set may include the “scan item” function, the “accept scan” function, etc. In addition, the second function set may include one or more custom functions 520 and 530, which are user-specified. The custom functions 520, 530 may be single functions or a combination of functions. For example, the custom function 520 may be a predetermined function for which the user has specified a custom triggering pattern, while the custom function 530 may be a combination of predetermined functions (e.g., scan item, accept scan and confirm selection) for which the user has also specified a custom triggering pattern. Thus, the device 100 may be programmed to access functions using the custom triggering patterns.

The function table 500 also includes a code representation list 512, which, compared to the description of the triggering patterns previously discussed with reference to the activation sequence list 412, is a lower-level representation of the triggering patterns. The code representation list 512 may, for example, be the same as, or substantially similar to, a representation of the triggering patterns as presented to the user by the scanning application. For example, the user interface may represent a hold with a first symbol (e.g., an asterisk) and a click with a second symbol (e.g., a dashed line). When the user enters a custom triggering pattern (e.g., a custom triggering pattern for the custom function 520), the processing device determines whether the user is entering a hold or a click, and displays this accordingly using the first and/or the second symbol. Thus, the user can enter a series of one or more symbols representing the custom triggering pattern. For example, as seen in FIG. 4, the custom triggering pattern for the custom function 520 may be “-*-” (i.e., a first click followed by a hold and a second click).

In an exemplary embodiment, the entering of the custom triggering patterns may be performed using the device 100 and the processing device. For example, the user may initiate the training mode using the device 100, access the function table 500 via the scanning application, and enter the triggering patterns using the device 100. In other embodiments, it may be possible to enter the triggering patterns using the processing device in addition, or in alternative, to the device 100. Additionally, although FIGS. 3 and 4 were described with reference to the trigger 130, those of skill in the art will understand that the functions described are also applicable to other devices (e.g., the device 200) according to the present invention. For example, in other embodiments, the triggering patterns described may be modified to be compatible with the trigger 230.

The scanning application may perform a check on any custom triggering pattern entered by the user. When a new triggering pattern is entered (either as a new custom function, or a modification of an existing function), a determination may be made whether the new triggering pattern conflicts with one or more existing triggering patterns. For example, a conflict may occur if part or all of the new triggering pattern is substantially similar to the existing triggering pattern(s). However, a conflict need not always be resolved. For example, as shown in FIG. 4, the “cancel scan” function and the “cancel selection” function utilize the same triggering pattern. Nevertheless, the scanning application may be able to distinguish whether the user intends to cancel a scan or cancel a previous selection. For example, if the scanning application has received scanned data, the scanning application may be expecting the “accept scan” function or the “cancel scan” function. In either case, the scanning application may assume that an input consisting of a double click corresponds to the “cancel scan” function rather than the “cancel selection” function. Thus, the scanning application may manage the triggering patterns and circumvent conflicts when possible.

If a conflict cannot be avoided, the scanning application may indicate this to the user (e.g., via the user interface) and prompt for a new triggering pattern. In an exemplary embodiment, the scanning application may present the user with one or more alternative triggering patterns that do not cause a conflict. The alternative triggering patterns may be determined by modifying the new triggering pattern.

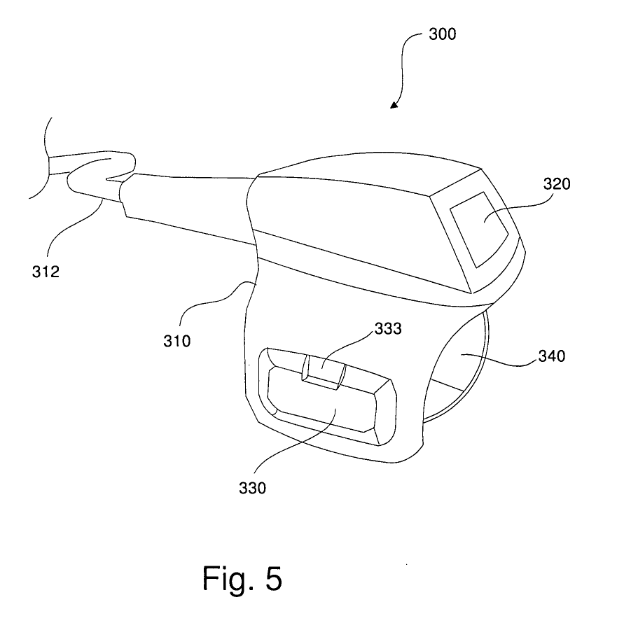

FIG. 5 shows an exemplary embodiment of a data acquisition device 300 according to the present invention. The device 300 may include a housing 310 comprising a scanning arrangement 320, a first trigger 330 and a second trigger 333. The device 300 may also include a communication arrangement 312 and an attachment arrangement 340. The first trigger 330 may be substantially similar to the trigger 130 and may, for example, include a flexible membrane and a generally convex shape. The second trigger 333 may be disposed adjacent to, or within, the first trigger 330. For example, the second trigger 333 may be located within a recess on an outer perimeter of the first trigger 330. The triggers 330, 333 may be engaged independently such that activation of one does not cause activation or interfere with operations of the other. In other embodiments, the second trigger 333 may not be located within (e.g., physically separated from) the first trigger 330.

The first trigger 330 may function in substantially the same manner as the trigger 130. That is, the triggers 330, 333 may both be capable of producing clicks and holds. However, the triggers 330, 333 may have different purposes. For example, the trigger 330 may be used to initiate a scan and the trigger 333 may be used to accept and/or confirm the scan. Thus, the functions comprising the function lists 410 and 510 may be divided between the triggers 330, 333.

One exemplary method of dividing the functions between the triggers 330, 333 according to the present invention is, as previously discussed, to assign individual functions to each of the triggers 330, 333. Another exemplary method of dividing the functions is to assign portions of the triggering patterns to each trigger 330, 333. For example, the holds may be entered via the first trigger 330 and clicks may be entered via the second trigger 333. Thus, according to the function list 500 shown in FIG. 4, one or more functions (e.g., “scan item”) may be entered using only the first trigger 330; one or more functions (e.g., “accept scan”, “cancel scan”, etc.) may be entered using only the second trigger 333; and one or more functions (e.g., the custom function 520) may be entered using both triggers 330, 333.

As seen from the examples described above, both triggers 330, 333 may be programmable. That is, both triggers 330, 333 may be used to enter the custom triggering patterns. However, in other embodiments, one of the triggers (e.g., the trigger 333) may not be programmable. For example, the trigger 333 may only be used for confirming a scan/selection while the trigger 330 is used to initiate a scan and enter the custom trigger patterns.

In addition, it will be understood by those skilled in the art that data acquisition devices according to the present invention need not be limited to two triggers, and other embodiments may utilize any number of triggers. Furthermore, the exemplary embodiments of the devices 100-300 have been described with reference to an entering of triggering patterns via a plurality of input types (e.g., holds and clicks). However, in other embodiments, the triggering patterns may be entered using only a single input type (e.g., a click). In these other embodiments, the triggering patterns may be entered by, for example, engaging a single trigger, a individual functional portion, or multiple triggers one or more times each, depending on a function to be entered.

The present invention allows the user to complete the scanning procedure using only the data acquisition device. Interaction between the user and the processing device may not be necessary. The advantages of the present invention can readily be seen in scenarios in which accessing the processing device is inconvenient (e.g., the processing device is in a remote location, the user must drop the item, the user is occupied with another activity such as writing) or dangerous (e.g., the user is handling hazardous materials, performing a critical operation, etc.).

Additionally, the customized triggering patterns enable function access in an easily remembered manner. The user can add, remove, or edit the triggering patterns as desired, increasing a likelihood that the user will recall the triggering patterns. Furthermore, the present invention provides access to an enhanced set of functions (e.g., the second function set). In addition to accessing a set of functions larger than that which could be accessed via a conventional data acquisition device, the user can define custom functions, thus simplifying complex procedures that require use of a plurality of functions. If the complex procedures are performed often (e.g., routinely), this may result in a substantial reduction in usage time.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

1. A wearable data acquisition device, comprising:
a data acquisition arrangement collecting data; and
a wearable trigger arrangement activating at least one function, the at least one function including at least one of activating the data acquisition arrangement and a data operation function,
wherein an operation of the trigger arrangement in a triggering pattern corresponding to each of the functions is user-programmable.

2. The device according to claim 1, wherein the data acquisition arrangement includes at least one of a barcode scanner, an RFID reader, a laser-based scanner, an image-based scanner and a card reader.

3. The device according to claim 1, wherein the data operation function is at least one of accepting the collected data, canceling the collected data, confirming the acceptance of the collected data and confirming the cancellation of the collected data.

4. The device according to claim 1, wherein the data operation function is a user defined combination of functions.

5. The device according to claim 1, wherein the programming is performed during a training mode of the device.

6. The device according to claim 1, wherein the programming is performed on a separate device.

7. The device according to claim 1, wherein the trigger operation includes at least one of a single click, a double click, a press-and-hold and a press-and-release.

8. The device according to claim 7, wherein a duration of a pause between clicks is user-programmable.

9. The device according to claim 7, wherein a duration of a hold is user-programmable.

10. The device according to claim 1, wherein the trigger arrangement includes a plurality of trigger mechanisms.

11. The device according to claim 10, wherein each of the plurality of trigger mechanisms activates at least one of the functions.

12. The device according to claim 1, wherein the device performs a determination of whether a first trigger operation corresponding to a first function conflicts with a second trigger operation corresponding to a second function.

13. The device according to claim 12, wherein if a conflict exists, the device attempts to circumvent the conflict by determining the user's intent when one of the first and the second trigger operations is performed.

14. The device according to claim 12, wherein if a conflict exists, the device prompts the user to program a new trigger operation.

15. The device according to claim 1, wherein each function is activated by a different one of the trigger operations.

16. The device according to claim 1, wherein at least one of the functions is performed at a separate device.

17. The device according to claim 16, wherein the separate device is a processing device that interprets the data.

18. A wearable data acquisition device, comprising:
a data acquisition means for collecting data; and
a wearable triggering means for activating a plurality of functions, the functions including at least one of activating the data acquisition means and a data operation function,
wherein an operation of the triggering means in a triggering pattern corresponding to each of the functions is user-programmable.

19. A method, comprising:
collecting data using a data acquisition arrangement;
receiving an input corresponding to a trigger operation of a wearable trigger arrangement, the trigger operation being in a triggering pattern; and
performing an operation on the collected data, the operation corresponding to the input,
wherein the correspondence between the operation and the input is user-configurable.

20. The method according to claim 19, wherein the operation is one of accepting the collected data, canceling the collected data, confirming the acceptance of the collected data and confirming the cancellation of the collected data.

21. A trigger arrangement for a wearable data acquisition device, comprising:
a wearable trigger receiving an input to activate at least one function, the at least one function including at least one of an activation of a data acquisition arrangement and a data operation function; and
a user-programmable circuit arrangement coupled to the trigger,
wherein an operation of the trigger in a triggering pattern corresponding to each of the at least one function is user-programmable using the user-programmable circuit arrangement.
